(19) United States
(12) Patent Application Publication
(10) Pub. No.: US 2011/0260440 A1
(43) Pub. Date: Oct. 27, 2011

(54) DISPOSABLE CUP WITH INTERNAL AND EXTERNAL FLUID LEVEL INDICATORS AND METHOD

(76) Inventors: Maurice HAFF, Bethesda, MD (US); John M. White, Bethesda, MD (US)

(21) Appl. No.: 12/955,409

(22) Filed: Nov. 29, 2010

Related U.S. Application Data
(60) Provisional application No. 61/327,887, filed on Apr. 26, 2010.

(51) Int. Cl. B42D 15/00; B65D 85/00

(52) U.S. Cl. 283/67; 206/459.1

(57) ABSTRACT

A method for using an associated visual implementing apparatus with which a first person may audibly or otherwise specify, e.g., a head nod, to a second person the amount of unoccupied volume or void to be available in an illustrated cup when partially filled with coffee or other liquid, in response to an easily understood inquiry by the second person. The method includes the steps of a first person exhibiting the illustrated cup to a second person while inquiring as to the unoccupied volume desired to remain while making reference to the illustrated cup. The visual implementing apparatus cup includes repeating vertically oriented illustrations, the illustrations being at least one of representations of human fingers, cows, text based words describing cow sounds, numbers, geographic shapes, logos, and/or indentations. The repeating illustrations being representative of the relative remaining proportional void levels in the cup and residing on at least one of the exterior and/or the interior of the cup near the rim thereof.

This application claims the benefit of U.S. provisional application Ser. No. 61/327,887, filed Apr. 26, 2010.

### BACKGROUND OF THE INVENTION

1. Field of the Invention

The present invention is related to simultaneously extracting explicit instructions from a customer and providing those instructions reliably to a server providing coffee service using a graphical depiction of the instructions to aid in the information transfer. More particularly, the invention is directed to an apparatus and associated method(s) of obtaining specificity as to the volume of coffee to be placed in a cup or the unoccupied volume (void) to remain for subsequent addition of a diluting agent, after partial filling of a cup with coffee, tea, syrup, etc.

2. Background of the Invention and Related Art

According to the National Coffee Association, coffee consumption in the United States reached 400 million cups per day in 2008. Growth in the out-of home specialty coffee market has remained strong, even in a down economy. The specialty coffee industry has grown dramatically over the two decades beginning in 1990. A good example of this growth is that experienced by the Starbucks company. After completing a public stock offering in the 1990s, Starbucks has grown to more than 15,000 stores worldwide, each store serving 100s if not 1,000s of cups of coffee each day. Some estimates of annual disposable cup usage by Starbucks (alone!) are reported to be about 4 billion units. According to Wikipedia, there are 100s of other coffee service chains doing business around the world as well. Estimates of total disposable cup usage by the retail coffee service industry exceed 200 billion units.

The following are identified as a partial listing of coffee service chains: Allann Brothers (Oregon, USA); AMT Coffee (mostly at railway stations); Aroma Espresso Bar (Israel); Au Bon Pain; Bagels and beans (Netherlands); Balzac Coffee (Germany); Barnie's Coffee and Tea Company; Barista Coffee (India); Biggby Coffee; Blenz (Canada); Blue Castle Coffee (Battle Ground, Wash., USA); Bridgehead Coffee (Ottawa, Canada); Cafe Coffee Day (India); Café Hillel (Israel); Café du Monde (USA); Caffé Nero (UK); Caffè Ritazza; Cafe Rouge; Campus Suite; Caribou Coffee (USA)• Clements Café (Belfast, Northern Ireland); CC's Coffee (Based in Baton Rouge); The Coffee Bean & Tea Leaf (USA); Coffee 1; Coffee Beanery; CoffeeBull Pty Ltd (Perth, Australia); Coffee-Inn (Lithuania); Coffee People; Coffee Republic (UK); Coffee Heaven (operates in several countries in Eastern Europe); coffee Planet Corporation; Coffee Time (Canada); Country Style Donuts (Canada); Costa Coffee (UK); Cuppy's Coffee; Davinci Coffee (South Korea); Diedrich Coffee (also owns Coffee People, Coffee Plantation (Arizona) and US Gloria Jean's locations); Dome (Australia); Double Coffee (in the Baltic states and Ukraine); Doutor (Japan); Douwe Egberts (Netherlands); Dunkin' Donuts (USA); Dunn Bros (USA); Duran Coffee Store (Panama); Dutch Bros. Coffee; 85C Bakery Cafe (Republic of China (Taiwan)); Fanzin Coffee & Tea (Turkey); Figaro (Philippines); Flocafé (Greece); Frans Café (Brazil); Gimme Coffee (USA); Gloria Jean's; Havanna (Argentina); Hollys Coffee (Korea, Japan and Malaysia); Hudsons Coffee (Australia); Intelligentsia Coffee & Tea (USA); It's a Grind Coffee House (USA); Nairobi Java House (Kenya); Java U (Canada); Jittery Joe's (USA); Juan Valdez Cafe Colombia; Kaffebrenneriet (Norway); Kotowa Coffee House (Panama); Krispy Kreme (USA); Lavazza (Europe); Lettieri (Canada); McCafe (owned by McDonald's Corporation); Mecca Espresso (Australia); Mokador—Concept Bars (Italy & Worldwide); MUD Coffee; Mugg & Bean (South Africa); Muzz Buzz (Australia); Narasus coffee (India); New World coffee (New York, USA); Old Town White Coffee (Malaysia); Pacific Coffee Company (Hongkong); Peaberry Coffee (USA); Peet's Coffee & Tea (USA); Port City Java (USA); PT's Coffee Roasting Co.; Robin's Donuts (Canada); Harris Coffee Roasters (New Zealand); Second Cup (Canada); Segafredo Zanetti (Italy); Starbucks; [symbol] en Karde [symbol] ler Kiraathanesi (Originated in Turkey, very big Franchising); Pasqua Coffee; Seattle's Best Coffee (USA); Secret Recipe (MALAYSIA); Sleepless In Seattle (South Korea); Torrefazione Italia (USA); Stumptown Coffee Roasters (USA, originated in Portland, Oreg.); Tchibo (Germany); Tim Hortons (also owns Bess Eaton) (Canada); Timothy's World Coffee (Canada); Trung Nguyen Coffee (Vietnam); Tully's Coffee (USA); Ueshima Coffee Company (Japan); Van Houtte (Canada); Wayne's Coffee (Originated in Sweden, locations throughout Scandinavia); Williams Fresh Cafe (Canada); Woyton (Germany); Ya Kun Kaya Toast (a chain of kopitiams based in Singapore); Zarraffas Coffee. Given the immensity and the widespread appeal of coffee and the accompanied dilution thereof, the scope for application of this invention is accordingly large as well.

Many of these coffee chains attempt to differentiate their coffee products by various roasting methods that produce differing degrees of bold flavor. Companies such as Starbucks are known for their heavily roasted coffees. For those customers that prefer dilution of such bold flavored coffees with liquids such as cream, “half & half” or milk, the serving portions often leave insufficient room in the cup in which to place the personally desired quantity of such diluting agents.

Instructions regarding the amount of “room for cream” given to a server by a customer purchasing a cup of coffee often lack sufficient specificity to produce adequate remaining unoccupied volume in the cup to accommodate the amount of diluting agent desired by the customer. This often results in the outcome where the customer, after noting that there is insufficient unoccupied volume remaining in the cup, pouring out a portion of the coffee. This disposal is usually done in a conveniently in-store located trash can lined with a thin walled plastic bag that is potentially subject to melting when exposed to a the extremely hot beverage.

The result of the foregoing sequence of events is wasted coffee and the potentially excessive mess of a melted liner in a trash can also filled with trash. The wasted coffee represents significant lost revenue and lost profit to a retail establishment doing large retail volume such as Starbucks. Had the cup, and 1,000s like it, not been over filled, the dumped coffee could have been used to fill 100s of other cups sold to subsequently served customers. From a per-unit-of-product sold perspective, the amount of coffee beverage that must be produced to fill the cups sold would be reduced by eliminating over-fill waste. Such elimination of waste would also reduce the “cost of goods sold” and increase the amount of profit obtained from the sale of each cup of coffee. In addition, if the plastic liner in a trash can is melted by hot coffee dumped in the can, the liner may fail when removed from the can, creating a mess on the floor that must be cleaned up by an employee. This situation represents increased operating costs due to lost productivity.

Currently, the cups used in the industry lack any visible delineation of the fill level in the cup and do not provide an explicit means for extracting from a customer instructions as to the amount of unoccupied volume desired to accommodate a diluting agent. Thus, a means is needed to more specifically regulate the amount of coffee placed in a cup and to specify the unoccupied volume or void remaining. The regulated fill amount, and consequent proportionally unoccupied volume, having greater specificity in response to a customer's instructions simply solicited by serving staff personnel through easily understood inquiry, would eliminate waste, reduce cost, increase profit, and avoid trash can bag failures.

### SUMMARY OF THE INVENTION

The present invention is directed to providing a method and apparatus for regulating the amount of coffee beverage placed in a cup by a server in response to a customer's explicit instructions.

More particularly, the present invention is directed to providing an explicit method and a visual implementing apparatus with which a customer can specify the amount of coffee beverage placed in a cup by a server, the customer responding to an easily understood inquiry by the server.

In another preferred embodiment, the present invention is directed to providing an explicit method and visual implementing apparatus with which a customer may specify the amount of unoccupied volume to be available in a cup when partially filled with coffee beverage, in response to an easily understood inquiry by a server, the cup being annotated with level markings on at least one of the exterior and/or the interior of the cup.

In another preferred embodiment, the present invention is directed to providing an explicit method and a visually implementing apparatus by which a server may obtain greater specificity from a customer as to the amount of coffee beverage to be placed in a cup, the cup being annotated with level markings on at least one of the exterior and/or the interior of the cup.

In another preferred embodiment, the present invention is directed to providing an explicit method and a visually implementing apparatus by which a first server may obtain greater specificity from a customer as to the unoccupied volume to be available in a cup when partially filled with coffee beverage by a second server, said specificity of unoccupied volume being conveyed from the first server to the second server audibly or by placing physical markings on the cup, said unoccupied volume being available for addition of a diluting agent, such as milk, cream, artificial flavoring substances, or any combination thereof.

In another preferred embodiment, the present invention is directed to providing a method for training serving staff personnel to conserve beverages served in a cup, including beverages such as coffee and tea, the method enabling the serving staff personnel to enhance their skill in judging the amount of unoccupied volume in the cup that will satisfy a response by a customer to inquiry by the serving staff personnel such as “leave room for cream”, the cup being annotated with level markings on at least one of the exterior and the interior of the cup.

In another preferred embodiment, the present invention is directed to providing a method for training serving staff personnel to mix beverages served in a cup, including prepared beverages such as coffee cappuccino, the method enabling the serving staff personnel to enhance their skill in judging the amount of different ingredients to be placed in a cup, the cup being annotated with level indicators on at least one of the exterior and/or the interior of the cup.

### BRIEF DESCRIPTION OF THE DRAWINGS

FIG. 1 is a drawing of a first and a second paper cup annotated on the exterior.

FIG. 2 is a flow diagram of a method of using a paper cup graphically annotated with fill level indicators.

FIG. 3 is a drawing of a paper cup graphically annotated on the interior with fill level indicators.

FIG. 4 is a drawing of a paper cup presently used by the Starbucks company showing graphical images displayed on the cup such as a logo.

FIG. 5 shows another type of indicator for the rate of final dilution of the cup contained beverage.

### DETAILED DESCRIPTION OF PREFERRED EMBODIMENTS OF THE INVENTION

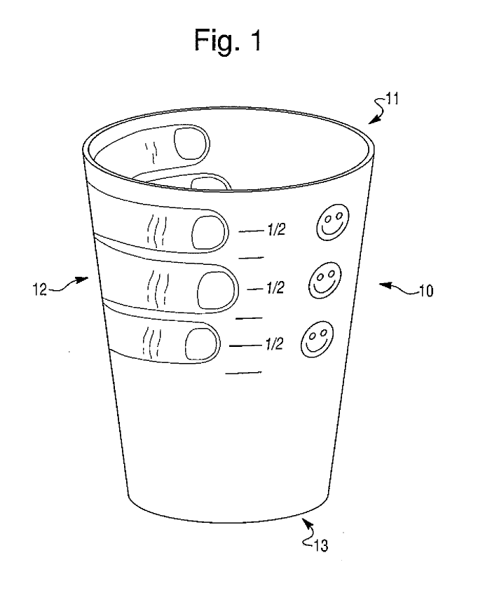

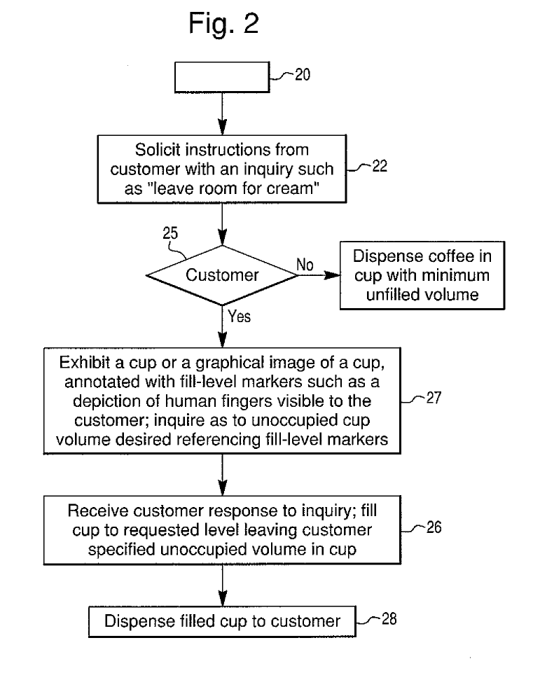

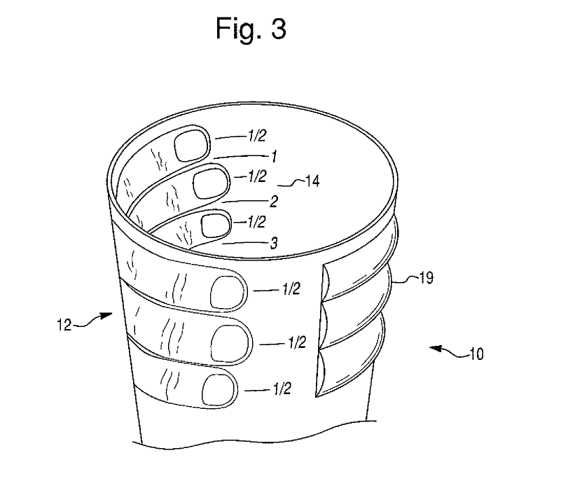

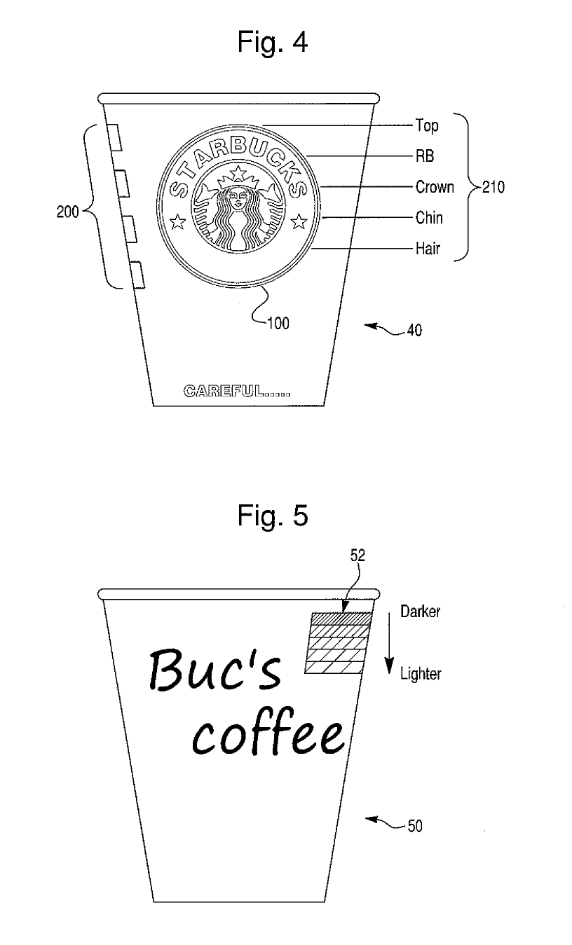

In brief: FIG. 1 is a drawing of a first and second paper cup each graphically annotated on the exterior with a graphic image of three human fingers serving as fill level indicators with which a server can inquire of a customer specificity as to the volume of coffee desired as a ratio to unoccupied volume to remain for accommodating a diluting agent, such as milk, cream, artificial flavoring substances, or any combination thereof. FIG. 2 is a flow diagram of a method of using a paper cup graphically annotated with fill level indicators to extract from a customer specific instructions as to the desired amount of coffee in relation to the unoccupied volume after filling, the unoccupied volume being available for addition of a diluting agent such as milk, cream, artificial flavoring substances, or any combination thereof. FIG. 3 is a drawing of a paper cup graphically annotated on the interior with fill level markers with which a server can inquire of a customer specificity as to the volume of coffee desired as a ratio to unoccupied volume to remain for accommodating a diluting agent such as milk, cream, artificial flavoring substances, or any combination thereof. FIG. 4 is a drawing of a paper cup presently used by the Starbucks company showing graphical images displayed on the cup such as the Starbucks logo that could be used by a server as reference points in determining specificity as to the volume of coffee desired as a ratio to unoccupied volume to remain for accommodating a diluting agent such as milk, cream, artificial flavoring substances, or any combination thereof.

In detail: Referring now to FIG. 1, there is shown a schematic illustration of one preferred embodiment of the present invention 10 illustrating a representation of easily conveyed and understandable graphical fill level indicators 12 in the form of line drawings of human fingers oriented perpendicular to a vertical line extended through the fillable volume of a cup, from base 13 to rim 11, and partially extending around the circumference of the cup. In response to an audible first person customer request or visual que to a server to “leave room for cream”, the second person server may obtain greater specificity as to the desired cup-to-cup proportional unoccupied volume (void) to remain in the cup through an easily understood audible or visual inquiry by the server of “one finger, two fingers, or three fingers” while exhibiting the illustrated cup to the customer. The customer will understand that three fingers represent a greater unoccupied volume for accommodating a greater volume of a diluting agent than does one or two fingers. Armed with this level of specificity, the server can provide the customer with the coffee product as desired by the customer either directly or through a third person order filler, while eliminating or at least reducing the likelihood that the customer will dump a portion of the coffee, wasting what could otherwise be sold to another customer.

Referring to FIG. 1, there is shown a schematic illustration of another preferred embodiment of the present invention 20 illustrating a representation of easily conveyed and understandable fill level indicators 22 in the form of line drawings of human fingers oriented parallel to a vertical line extended through the fillable volume of a cup, from base 23 to rim 21, and partially extending around the circumference of the cup. In response to a customer request to a server to “leave room for cream”, the server may obtain greater specificity as to the desired cup-to-cup proportional unoccupied volume (void) to remain in the cup through an easily understood inquiry by the server such as “one finger, two fingers, or three fingers” while exhibiting the illustrated cup to the customer. The customer will understand that three fingers represent a greater unoccupied volume for accommodating a greater volume of a diluting agent than does one or two fingers. Armed with this level of specificity, the server can provide the customer with the coffee product as desired by the customer, while eliminating or at least reducing the likelihood that the customer will dump a portion of the coffee, wasting what could otherwise be sold to another customer.

While the cups used to dispense coffee in retail outlets are often comprised of paper, and in some cases an insulating material, it is anticipated that sealant covered graphical fill level illustrations as described in the present invention can also be deposited upon cups made of other materials, such as plastic or Styrofoam in addition to those made of paper. Cups fabricated from materials such as paper, plastic, and Styrofoam are generally intended to be disposable.

Referring now to FIG. 2, in one preferred embodiment shown in chart 20, a server can solicit explicit instructions 22 from a customer as to the desired unoccupied volume to remain after partial filling of a cup with coffee, by first making a general inquiry of a customer such as “leave room for cream” and if the answer is in the partial/uncertain affirmative 25, then making a more specific inquiry 27. The more specific inquiry by a server can be facilitated by exhibiting to the customer a cup illustrated with drawings or photographs of human fingers as shown in FIG. 1, accompanied by a verbal inquiry such as “one finger, two fingers, or three fingers.” Because of the verbal inquiry and the relative placement of the illustrated human fingers 12 or the number of human fingers 22 on the exhibited cup in FIG. 1, the customer will recognize the relative unoccupied volume that will remain in the cup after partial filling by the server. Armed with that recognition, the customer can make an informed decision knowing their preferred ratio of coffee to dilution agent. The result of the customer's decision can be conveyed to the server in clearly understandable and quantifiable terms, such as “one finger” or “two fingers” or “three fingers”, that can be acted upon specifically by the server at 26 and the cup with sufficient void for dilution is provided at 28.

The method disclosed in FIG. 2 can also be used to train serving staff personnel to conserve beverages served in a cup, including beverages such as coffee and tea, the method enabling the serving staff personnel to enhance their skill in judging the amount of unoccupied volume in the cup that will satisfy a response by a customer to inquiry by the serving staff personnel such as “leave room for cream”, the cup being annotated with level markings on at least one of the exterior and the interior of the cup.

The method disclosed in FIG. 2 can also be used for training serving staff personnel to mix beverages served in a cup, including prepared beverages such as coffee cappuccino, the method enabling the serving staff personnel to enhance their skill in judging the amount of different ingredients to be placed in a cup, the cup being annotated with level markings on at least one of the exterior and the interior of the cup.

Referring now to FIG. 3, there is shown a schematic illustration of another preferred embodiment of the present invention 10 illustrating a representation of fill level indicators 14 easily understandable by a server and corresponding to substantially equivalent indicators 12 residing on the exterior of the cup, and configured in the form of line drawings of human fingers oriented perpendicular to a vertical line extended through the fillable volume of a cup and partially extending around the interior circumference of the cup.

In another preferred embodiment, an alternative illustration form may be used instead of or in addition to the finger illustrations as fill level indicators and may be augmented by ½ indicators (or further finer divisions ¼, ⅛, etc.) to provide further precision. An illustration such as multiple cows or other symbols (i.e. smiley faces, brand marks, etc.) shown one above the others can be applied to the exterior of the cup. In response to a customer request to a server to “leave room for cream”, the server may obtain greater specificity as to the desired unoccupied volume to remain in the cup through an easily understood inquiry of “one cow, two cows, or three cows” while exhibiting the illustrated cup to the customer. The customer will understand that three cows represent a greater unoccupied volume for accommodating a greater volume of a diluting agent than does one or two cows. Armed with this level of specificity, the server can provide the customer with the coffee product as desired by the customer, while eliminating or at least reducing the likelihood that the customer will dump a portion of the coffee, wasting what could otherwise be sold to another customer. The cups may also be illustrated on the interior with substantially corresponding cows to provide the server with a means to more accurately gage the amount of unoccupied volume to retain in the cup.

In another preferred embodiment, an alternative illustration form may be used instead of the finger or cow illustrations as fill level indicators. An illustration of multiple text based words representing the sounds verbalized by cows such as “moo” can be shown one above the others applied to the exterior of cup. Numbers may also be applied in combination with text. In response to a customer request to a server to “leave room for cream”, the server may obtain greater specificity as to the desired unoccupied volume to remain in the cup through an easily understood inquiry of “one moo, two moos, or three moos” while exhibiting the illustrated cup to the customer. The server may optionally elect to mimic a bovine sound while articulating the word “moo”. The customer will understand that three moos represent a greater unoccupied volume for accommodating a greater volume of a diluting agent than does one or two moos. Armed with this level of specificity, the server can provide the customer with the coffee product as desired by the customer, while eliminating or at least reducing the likelihood that the customer will dump a portion of the coffee, wasting what could otherwise be sold to another customer. The cups may also be illustrated on the interior with substantially corresponding text to provide the server with a means to more accurately gauge the amount of unoccupied volume to retain in the cup.

In another preferred embodiment, alternative but perhaps less entertaining illustrations may be used instead of the finger, cow, or text illustrations as fill level indicators. An illustration in the form of simple bars can be applied to the cup comprising lines shown one above the other oriented perpendicular to a vertical line extended through the fillable volume of the cup and partially extending around the circumference of the cup. The bars may alternatively be applied in parallel to said vertical line with the bars being of differing lengths, where the lengths represent different fill levels. In response to a customer request to a server to “leave room for cream”, the server may obtain greater specificity as to the desired unoccupied volume to remain in the cup through an easily understood inquiry such as “one bar, two bars, or three bars” while exhibiting the illustrated cup to the customer. The customer will understand that three bars represent a greater unoccupied volume for accommodating a greater volume of a diluting agent than does one or two bars. Armed with this level of specificity, the server can provide the customer with the coffee product as desired by the customer, while eliminating or at least reducing the likelihood that the customer will dump a portion of the coffee, wasting what could otherwise be sold to another customer. The cups may also be illustrated on the interior with substantially corresponding bars to provide the server with a means to more accurately gage the amount of unoccupied volume to retain in the cup.

In preferred embodiments where images, text, or bars are applied to the interior of a cup, sealants may be employed to prevent the substance used to apply the images, text, or bars from being dissolved by liquids with which the cup may be filled.

In another preferred embodiment, alternative but perhaps even less entertaining fill level indicators may be used instead of the finger, cow, text, or bar illustrations. Fill level indicators in the form of simple highlighted indentations 19 can be applied to a cup shown one above the other oriented perpendicular to a vertical line extended through the fillable volume of the cup and partially extending around the circumference of the cup. In response to a customer request to a server to “leave room for cream”, the server may obtain greater specificity as to the desired unoccupied volume to remain in the cup through an easily understood inquiry of “one dent, two dents, or three dents” while exhibiting the illustrated cup to the customer. The customer will understand that three dents represent a greater unoccupied volume for accommodating a greater volume of a diluting agent than does one or two dents. Armed with this level of specificity, the server can provide the customer with the coffee product as desired by the customer, while eliminating or at least reducing the likelihood that the customer will dump a portion of the coffee, wasting what could otherwise be sold to another customer. The indentations applied to the cup may be made sufficiently deep so as to be visible on the interior to provide the server with a means to more accurately gage the amount of unoccupied volume to retain in the cup.

A similar apparatus and method may be likewise employed for ordering alcoholic mixed beverages. The customer may specify 1 cube, 2 cubes, 3 cubes, to describe the quantity of high proof alcohol containing beverage to be added to the consuming cup before dilution by an additive, i.e., juice, soda, etc. The indicators may be drawings of cubes, brand images, progressively tipsy smiley faces, college mascots, etc. proceeding upwardly from a lower portion of the disposable cup. The bartender may have a price chart relating to the increased high proof liquid quantity. A customer may order a “3 Cowboy” gin and tonic. This would indicate that the gin added predilution would be 3 “Cowboy” mascots deep. The more specific the instructions, the more satisfied the customer.

Referring to the schematic illustration of FIG. 3, in another preferred embodiment a two dimensional graphic image may be employed in the method of the present invention displaying a representation of fill level indicators 14 on a cup 10, easily understandable by a server and corresponding to substantially equivalent indicators 12 residing on the exterior of the cup, and configured in the form of line drawings of human fingers, cows, or other graphic images including logos, text or bars as previously disclosed, oriented perpendicular to a vertical line extended through the fillable volume of a cup, from base 13 to rim 11, and partially extending around the interior circumference of the cup. In response to a customer request to a server to “leave room for cream”, the server may obtain greater specificity as to the desired unoccupied volume to remain in the cup through an easily understood inquiry such as “one finger, two fingers, or three fingers” or “one cow, two cows, or three cows” while referencing the displayed graphic image of the illustrated cup to the customer. The customer will understand that an indication such as three cows represents a greater unoccupied volume for accommodating a greater volume of a diluting agent than does an indication such as one or two cows. Armed with this level of specificity, the server can provide the customer with the coffee product as desired by the customer, while eliminating or at least reducing the likelihood that the customer will dump a portion of the coffee, wasting what could otherwise be sold to another customer or reducing the amount of coffee needed to satisfy a customer purchase and lower the cost of goods sold. The cups provided to customers may also be manually illustrated by the server marking on the exterior of the cup with a marking device, the markings substantially corresponding to the number of fingers, cows, or other images to provide the server with a means to more accurately gage the amount of unoccupied volume to retain in the cup.

In another preferred embodiment of the method of the present invention, a cup may be displayed by a server to a customer, while making an inquiry regarding the desire for the use of cream. In response to a customer request to a server to “leave room for cream”, the server may obtain greater specificity as to the desired unoccupied volume to remain in the cup through an easily understood inquiry such as “one finger, two fingers, or three fingers” while referencing the server's fingers placed on the exterior of the cup substantially in the position of the finger image of the illustrated cup shown in FIG. 1. The customer will understand that an indication such as three fingers represents a greater unoccupied volume for accommodating a greater volume of a diluting agent than does an indication such as one or two fingers. Armed with this level of specificity, the server can provide the customer with the coffee product as desired by the customer, while eliminating or at least reducing the likelihood that the customer will dump a portion of the coffee, wasting what could otherwise be sold to another customer or reducing the amount of coffee needed to satisfy a customer purchase and lower the cost of goods sold. The cups provided to customers may be manually illustrated by the server marking on the exterior of the cup with a marking device, the markings substantially corresponding to the number of fingers indicated by the customer, providing the server with a means to more accurately gage the amount of unoccupied volume to retain in the cup.

In another preferred embodiment of the method of the present invention, a cup may be displayed by a server to a customer, while making an inquiry regarding the desire for the use of cream. In response to a customer request to a server to “leave room for cream”, the server may obtain greater specificity as to the desired unoccupied volume to remain in the cup through an easily understood inquiry referencing a graphical illustration printed on a cup to serve other purposes, such as a store brand logo. Referring to

FIG. 4, one example would be a server referencing the Starbucks logo 100 printed on the exterior of the cup 40 and making an inquiry such as “top of the logo” while displaying the cup to the customer. Any other graphical image printed on the cup could also be used as a reference point to obtain greater specificity as to the unoccupied volume to remain in the cup as desired by the customer. Images such as the rectangles and associated text 200 presently printed vertically between the top rim of the cup and the bottom rim on the Starbucks paper cups may be used as reference points in the method of the present invention. The server may make an inquiry such as “top of this box” while pointing to one of the rectangles printed on the Starbucks cup. The server may elect to mark the cup with a marking device to memorialize the customer's instruction.

In another preferred embodiment of the present invention as shown in FIG. 5, a cup 50 may be displayed by a server to a customer, the cup having a color band 52 positioned partially or entirely around the circumference of the upper portion of the cup, while making an inquiry regarding the desire for the use of cream. The color band may display a gradient of the employed color (for example but not limited to brown) the color gradient ranging from visually darker to lighter in shade from the top of the color band to the bottom of the color band. The shading in the color gradient approximately represents the resulting color of the coffee when the cup is filled with coffee to the level of a particular shade in the gradient and a diluting agent such as milk or cream is added up to a level near the top of the color band. The coffee when diluted with milk or cream would relatively resemble in shade the shading in the color band at the fill level selected by the customer. Variation would result depending on which diluting agent is used and the type and brew strength of coffee dispensed. In response to a customer request to a server to “leave room for cream”, the server may obtain greater specificity as to the desired unoccupied volume to remain in the cup through an easily understood inquiry such as “how much room for cream” while referencing the gradations in the color band 52. The customer would understand that the shades in the color band correspond approximately to the shade of the coffee beverage obtainable when the cup is filled with coffee beverage to a specific level in the color band and a volume of diluting agent such as milk or cream is subsequently added up to the top of the color band. The server may elect to place a mark in the color band on the cup with a marking device to memorialize the customer's instruction.

In another preferred embodiment, a first server having obtained greater specificity for the unoccupied volume desired by a customer may convey said specificity to a second server audibly by verbalizing words such as “one finger, two fingers, or three fingers” plus a description of the coffee product ordered such as “Grande” or other product descriptor. Words such as “one cow, two cows or three cows” or “one moo, two moos or three moos” plus the product descriptor may also be used. It is anticipated that any combination of words and sounds representing fill level indicators may be used with a product descriptor to convey to a second server the unoccupied volume specified by the customer to a first server.

In another preferred embodiment, images representing fill level indicators may be sized proportionally to the capacity of a cup on which they are printed, images dimensions on a larger capacity cup being larger than image dimensions on a smaller capacity cup, and thus representing a larger unoccupied volume to remain in the cup after filling with coffee or other beverage. For example, the image size of three fingers printed on a cup with a 12 ounce volume capacity may be less than the image size of three fingers printed on a cup having a 16 ounce volume capacity. Further, the relative size may correspond to a specific volume, such as one finger equal to one ounce, two fingers equal to two ounce, or any other volume amount that may be designated for manufacturing the cup.

Empirical evidence reveals unexpected results regarding the potential impact on corporate value resulting from deployment of the present invention. Evidence collected from brief interviews of serving staff at multiple Starbucks stores in several states in different regions of the United States (e.g. Maryland, Oklahoma, Utah, California) indicates that 40 to 50 percent of coffee beverage purchased is filter coffee and approximately 90 percent of Starbucks customers desire “room for cream” when purchasing a cup of filter coffee regardless of coffee type or cup size. Servers acknowledge that the specific amount of room for cream is unknown to them after customer affirmation that they desire “room for cream” in the cup, so the cup is filled to a greater level than desired by the customer about half the time, resulting in customer dumping into store trash receptacles a portion the coffee served. Reportedly, Starbucks presently uses approximately 3 billion disposable paper cups annually. Empirical evidence reveals that more than 1.2 billion cups of filter coffee (in the range of 40% to 50%) are served annually by Starbucks, with over 1 billion (approximately 90%) served where customers desire “room for cream” to remain in the cup. Considering that about half the time to make more “room for cream” customers dump a portion of the coffee served, that equates to dumping a portion of the coffee served from about 500 million cups. If the amount of coffee dumped is in the range of 5% to 10% of the volume of each cup, the result would be wasted coffee in a total volume in the range of 25 to 50 million cups. Reportedly the cost of the beverage content of filter coffee sold by Starbucks is approximately $0.20 per cup. Applying empirical evidence, this would indicate that the cost to Starbucks of the wasted coffee is in the range of $5 to $10 million per year. If this cost was avoided through implementation of the present invention by Starbucks company, profitability could be increased by as much as $10 million per year. Considering that as of June 2010, the price/earnings ratio reported for Starbucks was around 25 to 1, implementation of the present invention by Starbucks could increase the corporate value of Starbucks company by as much as $250 million, or about $0.30 per share outstanding.

In addition to reducing coffee waste and the cost of goods sold, implementation of the present invention by coffee service providers such as Starbucks, where the customer adds a diluting agent, will produce a more customized product and experience, responsive to customer instructions. Delivering a more customized product and experience will potentially result in greater customer satisfaction.

The present invention can also be employed by coffee service providers such as “Dunkin Donuts”, where diluting agents (e.g., cream) are added by the server before delivering the ordered coffee product to the customer. This would create a more customized product and experience for the customer, responsive to customer instructions. Delivering a more customized product and experience will potentially result in greater customer satisfaction.

While the invention has been described with reference to exemplary embodiments, it is understood that the words that have been used are words of description and illustration, rather than words of limitation. Changes may be made, within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods and uses, such as are within the scope of the appended claims.

We claim:

1. A method using a visual implementing apparatus with which a first person customer may specify to a second person server the amount of unoccupied volume to be available in an illustrated cup when partially filled with coffee or other liquid, in response to an easily understood inquiry by the second person server, the method comprising:
exhibiting the illustrated cup to the first person;
inquiring from the second to the first person as to the remaining unoccupied volume in the illustrated cup desired by the first person post filling of said cup with said liquid, during said inquiry step making reference to the illustrated cup, wherein the visually implementing apparatus being exhibited comprises the illustrated cup, the illustrations being vertically oriented on said cup near a rim of said cup and being at least one of representations of human fingers, cows, text based words describing cow sounds, numbers, repeating shapes, logos, and indentations, said illustrations representing relative remaining cup proportional void levels in the cup when filled in accord with expressed instructions of said first person, said illustrations residing on at least one of the exterior and the interior of the cup; and,
said first person specifying said remaining void to said second person by reciting a phrase identifying a cup void associated with the level of a recited illustration on said cup spaced from said rim.

2. The method of claim 1, wherein the amount of coffee to be placed in a cup is determined by the selection of the number of images of said human fingers, cows, text based words describing cow sounds, numbers, geographic shapes, logos, and indentations, as illustrated on the cup.

3. The method of claim 1, wherein said unoccupied volume determines the amount of a diluting agent that may be optionally added in a subsequent step by either of said first or second person.

4. The method of claim 1, wherein said unoccupied volume specification in combination with a product description is conveyed audibly by the second person server to a third person server.

5. The method of claim 1, wherein said illustrations are representative of the diluted appearance of said coffee or other liquid post dilution when said coffee or other fluid has been added to a threshold on said illustration corresponding to said diluted appearance.

6. A visual method implementing apparatus with which a first person may specify to a second person the amount of unoccupied void volume to be available in an illustrated cup when partially filled with coffee or other liquid, in response to an easily understood inquiry by the second person, the apparatus comprising:
a disposable cup including illustrations;
the illustrations being vertically oriented on said cup and including at feast one of representations of human fingers, cows, text based words describing cow sounds, numbers, geographic shapes, logos, and indentations, said illustrations representing relative fill levels in the cup and residing on at least one of the exterior and the interior of the cup.

7. The apparatus of claim 4, wherein;
the amount of coffee to be placed in a cup is determined by selection of the number of images of said human fingers, cows, text based words describing cow sounds, numbers, geographic shapes, logos, or indentations, as illustrated on the cup.

8. The apparatus of claim 4, wherein said unoccupied volume determines the amount of a diluting agent that may be added.

9. The apparatus of claim 4, wherein:
said illustrations are representative of the diluted appearance of said coffee or other liquid post dilution when said coffee or other fluid has been added to a threshold on said illustration corresponding to said diluted appearance.

10. The apparatus of claim 4, wherein said images are covered by a sealant.

11. A method for using a visually implementing apparatus in the form of an illustrated cup to train serving staff personnel to conserve beverages served in a cup, including beverages such as coffee and tea, the method comprising:
directing a first person to specify to a second person the amount of unoccupied volume to be available in an illustrated cup when partially filled with coffee or other liquid, in response to an easily understood inquiry by the second person exhibiting the illustrated cup;
directing the second person to inquire as to the unoccupied volume desired by the first person, making reference to the illustrated cup; wherein,
the visually implementing apparatus comprises the illustrated cup, the illustrations being at least one of representations of human fingers, cows, text based words describing cow sounds, numbers, geographic shapes, logos, and indentations, said illustrations representing relative fill levels in
the cup and residing on at least one of the exterior and the interior of the cup; and, wherein, the method enables serving staff personnel to enhance their skill in judging the amount of unoccupied volume in the cup that will satisfy a response by a customer to inquiry by the serving staff personnel to leave room for cream.
